(19) United States
(12) Patent Application Publication
(10) Pub. No.: US 2009/0031100 A1
(43) Pub. Date: Jan. 29, 2009

(54) MEMORY REALLOCATION IN A COMPUTING ENVIRONMENT

(76) Inventor: David Hansen, Beaverton, OR (US)

Correspondence Address: CENTURY IP GROUP, INC. [IBM US], P.O. BOX 7333, NEWPORT BEACH, CA, 92658-7333, US

(21) Appl. No.: 11/781,442

(22) Filed: Jul. 23, 2007

(51) Int. Cl. G06F 12/06

(52) U.S. Cl. 711/171; 711/E12.002

(57) ABSTRACT

Systems and methods for reallocating memory in a computing environment are provided. The method comprises deallocating first memory space allocated to a first software application in a first execution context, in response to determining that a first page size associated with the first memory space allocation is inappropriate for said first software application within a second execution context; and reallocating second memory space to the first software application responsive to the second execution context, such that a second page size associated with the second memory space allocation is appropriate for the first software application in the second execution context.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### FIELD OF INVENTION

The present invention relates generally to memory reallocation in a computing environment and, more particularly, to a system and method for transparently allocating a new page size to an application executed in a computing environment.

### BACKGROUND

In computer operating systems, paging refers to the process of managing a software application's access to virtual memory pages that do not currently reside in random access memory (RAM). Virtual memory is an addressing scheme implemented in hardware and/or software that allows non-contiguous memory to be addressed as if it were contiguous. Page size generally refers to the size of a memory block used by a processor architecture and the smallest possible size of memory that can be allocated to an application.

Typically, a system with a smaller page size uses more pages, requiring a page table that occupies more space. For example, if a 2³² virtual address space is mapped to 4 KB (2¹² bytes) pages, the number of virtual pages is 2²⁰ (20=32−12). However, if the page size is increased to 32 KB (2¹⁵ bytes), then 2¹⁷ (17=32−15) pages are required.

Rarely does a process require the use of an exact number of pages. As a result, the last allocated page is generally not fully utilized, resulting in some waste in memory usage. Larger page sizes increase the potential for wasted memory because more unused portions of memory are loaded into main memory.

As an example, assume the page size is 1 MB. Since 1 MB is equal to 1024 KB, if a process needs 1025 KB of memory space to operate, two 1 MB pages need to be allocated to the process, such that, for example, a first 1 MB page is used in its entirety, and a second 1 MB page is only partially used (e.g., 1024 KB used in the first 1 MB page, and 1 KB is used in the second 1 MB page) resulting in 1023 KB (i.e., 1 MB-1 KB) of unused space.

Some applications, however, require large amounts of memory to efficiently operate and therefore the operating system may allocate one or more large size pages (e.g., 16 MB pages) to an application prior to commencement of execution. This is because it is more efficient for an application to access large volumes of data allocated to a few large pages, in comparison to accessing the same data allocated to a plurality of smaller size pages. Despite of the above, it's desirable to use smaller page sizes when possible to ensure a closer match to the actual amount of memory required in an allocation procedure.

For the above reasons, if large pages allocated to an application are not fully utilized, it would be desirable to allocate smaller pages to that application to minimize waste. Unfortunately, once the memory is allocated to an application it cannot be deallocated during execution, unless the application is terminated. Most applications cannot determine whether memory allocation is mapped to large size pages or a small size pages; and as a result, most applications are not able or are not configured to switch between large and small page sizes after the operating system's initial memory allocation.

Occasionally, the operating system (or system library) improperly allocates page sizes that are either too large or too small for the needs of an application. That is, the operating system may improperly estimate the page size needed for an application and as a result may allocate a large page size to the application that cannot fully utilize it. Such scenario can result in waste of computing and memory resources, since it is not possible to change the page size allocated to a target application after it has started execution.

The problem is further exacerbated if an application (e.g., an application with a higher importance over the target application) is in dire need of additional memory, or when it would be more useful for another application to use large size pages already allocated to the target application. Thus, methods and systems are needed that can overcome the aforementioned shortcomings by transparently reallocating pages among applications being executing in a computing environment.

### SUMMARY

The present disclosure is directed to systems, methods and corresponding products that facilitate memory reallocation in a computing environment.

In accordance with one embodiment, a method for reallocating memory in a computing environment is provided. The method comprises deallocating first memory space allocated to a first software application in a first execution context. The deallocation may be in response to determining that a first page size associated with the first memory space allocation is inappropriate for said first software application within a second execution context. A second memory space may be allocated to the first software application responsive to the second execution context, such that a second page size associated with the second memory space allocation is appropriate for the first software application in the second execution context.

In another embodiment, a system comprising one or more logic units is provided. The one or more logic units are configured to perform the functions and operations associated with the above-disclosed methods. In yet another embodiment, a computer program product comprising a computer useable medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The invention is not, however, limited to any particular embodiment disclosed.

### BRIEF DESCRIPTION OF THE DRAWINGS

Embodiments of the present invention are understood by referring to the figures in the attached drawings, as provided below.

FIGS. 1 and 2 illustrate exemplary execution environments in accordance with one embodiment, wherein memory pages may be allocated and reallocated among software applications executed thereon.

FIG. 3 is a flow diagram of a method for reallocating pages to a software application, in accordance with one embodiment.

FIGS. 4 and 5 are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION OF EXEMPLARY EMBODIMENTS

The present disclosure is directed to systems and corresponding methods that facilitate reallocating memory in a computing environment. If it is determined that a first page size allocated to a software application is inappropriate, the memory space allocated to the software application is deallocated after the status of the software application is saved (e.g., stored in a storage medium). A second more appropriate page size is then used to allocate memory to the software application; and the execution of the software application is resumed according to the saved application status.

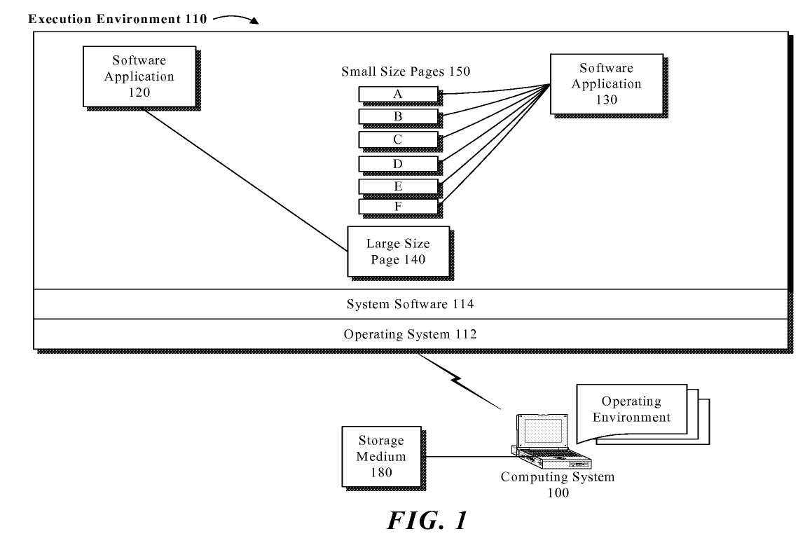

Referring to FIG. 1, an exemplary operating environment illustrated as execution environment 110 comprises an operating system 112 running on a computing system 100. System software 114 may run on top of the operating system 112 to facilitate and monitor allocation of memory and page sizes to one or more software applications 120, 130 running in execution environment 110.

In certain embodiments, system software 114 is part of operating system 112 or its kernel. In other embodiments, system software 114 is implemented as a separate and independently operating software and distinct from the operating system 112. System software 114 may, for example, be stored in a storage medium 180 connected to computing system 100, and may operate on top of operating system 112.

In the following, one or more embodiments are disclosed, by way of example, wherein system software 114 is executed independently on top of operating system 112 to manage memory allocation among software applications running in execution environment 110. Such exemplary embodiments, however, should not be construed as narrowing the scope of the invention to system software 114 that is independent of operating system 112.

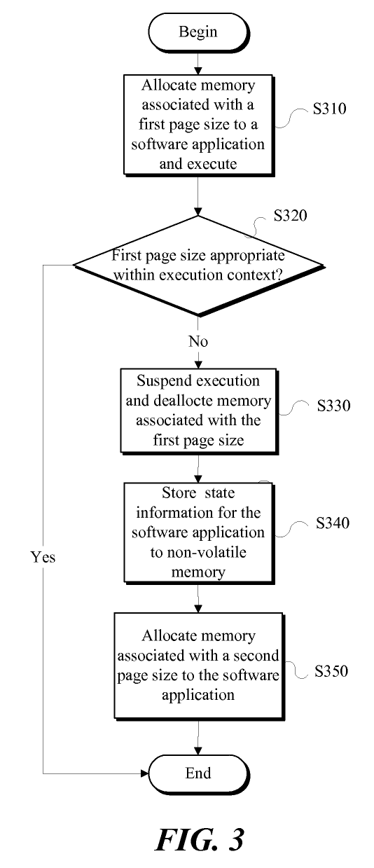

In one embodiment, the operating system 112 or the system software 114 may perform one or more processes illustrated in FIG. 3, as provided in more detail below.

As illustrated in FIG. 1, execution environment 110 supports an operating environment in which exemplary software applications 120 and 130 can be concurrently executed on top of operating system 112. Referring to FIGS. 1 and 3, memory associated with a first page size is allocated to a software application (S310). In one embodiment, the operating system 112 or system software 114 may allocate memory associated with a first page size to a software application and thereafter execute that software application. For example, operating system 112 or system software 114 may allocate a large size page 140 to software application 120 and several small size pages 150 to software application 130, and execute said software applications.

The initial page size allocated to each software application 120 or 130 is determined based on the context in which the software applications are being executed. Next, it is determined whether a first page size allocated to a software application is appropriate within the context in which the software application is being executed (S320). For example, in a first execution context, operating system 112 or system software 114 may determine that a large size page 140 should be allocated to software application 120 and several small size pages 150 should be allocated to software application 130. It is noteworthy, however, that within execution environment 110 memory resources may be allocated to other applications, such that the execution context for each software application may change.

For example, it is possible that a software application 130 with a higher level of importance or priority may need access to large size pages that are already allocated to software application 120. Accordingly, in one embodiment, system software 114 monitors the memory allocation and pages sizes in the system to determine whether a first page size allocated to software application 120 has remained appropriate for software application 120's needs within its execution context.

In other words, the memory allocated to and used by software application 120 is monitored to determine if a larger or smaller page size should be allocated to that software application. In some embodiments, for example, translation lookaside buffer (TLB) performance counters used to record data access hits and misses may be monitored to determine software application 120 memory access status and whether there is a need for larger or smaller page size allocation. A TLB is a cache in a central processing unit (CPU) of computing system 100 that is used to improve the speed of a virtual address translation.

In one embodiment, the TLB lookup is performed in parallel with the cache access. During a cache access, an index operation may be used to find an entry in the cache's data store. The cache may perform the index operation while the TLB translates the upper bits of the address. The translated address from the TLB may be passed to the cache. The cache performs a tag comparison to determine if this access was a hit or miss.

In one embodiment, when a TLB miss occurs, the CPU may monitor the page tables to determine if there is a valid page table entry for a specified virtual address. If an entry exists, that entry is fetched into the TLB and the TLB access is retried. If the CPU finds no valid entry for the virtual address in the page tables, the CPU may raise a page fault exception. The above scenarios are examples that may indicate to operating system 112 or system software 114 that the execution context of an application has changed.

Depending on implementation, operating system 112 or system software 114 may monitor the page tables and perform the translation in software. Operating system 112 or system software 114 may also load the translation into the TLB and restart the application from the instruction that caused a TLB miss. If operating system 112 or system software 114 find no valid translation in the page tables, a page fault may occur.

Referring back to FIGS. 1 through 3, in one embodiment, system software 114 may monitor TLB performance or other system parameters to determine if the memory is properly allocated among different applications being executed. Accordingly, applications that may need larger or smaller page sizes may be identified by system software 114.

If it is determined that memory needs to be reallocated among applications executed in execution environment 110, then an identified application may be suspended and memory associated with the pages sizes allocated to the identified application may be deallocated (S330). In one embodiment, system software 114 may determine that software application 120 is inefficiently utilizing large size page 140, or that software application 130 may be able to more efficiently use large size page 140 allocated to software application 120. If so, execution of software application 120 is suspended and large size page 140 is removed from memory space allocated to software application 120.

Next, the state information for the identified (i.e., suspended or to be suspended) software application and the related data being processed by the identified software application are stored in a storage medium (S340). In certain embodiments, software application 120's state information may be stored in a storage medium 180 connected to computing system 100.

Storage medium 180 may be a non-volatile memory (e.g., a hard disk drive, flash memory, etc.) and may be a storage medium that is independent and distinct from the storage medium (e.g., system memory—not shown) in which the data associated with software application 120 is stored. Thus, depending on implementation, the state information and, in some embodiments, related execution information and application data that are loaded into the memory pages allocated to software application 120 may be stored on a disk or other type of nonvolatile storage medium.

In certain embodiments, the state information may be stored in a transaction log that comprises a history of actions executed by software application 120, so that when software application 120 enters the suspended state, software application 120 can be restored to its pre-suspended state. In other words, the information stored in the transaction log may help reinstate software application 120 to a stable state, by way of rolling back the application to a saved state that is recorded prior to software application 120 entering the suspended mode.

In an exemplary embodiment, an application independent of system software 114 such as a checkpoint software (e.g., IBM® Metacluster line of products) may be used to store software application 120's state and other related information in storage medium 180 prior to software application 120 entering the suspended state. IBM is a registered trademark of International Business Machine Corporation. Checkpoint software refers to a software application that can be used to save the entire state of an application to persistent memory in case of an unforeseen failure (e.g., application crash or hardware failure).

In certain embodiments, prior to entering the suspended (e.g., checkpoint) state, software application 120 is quarantined so as to be removed or isolated from execution environment 110 to prohibit any interaction between the software application 120 and other applications being executed in the system, while software application 120 is in the suspended state. In some embodiments, any interaction between the software application 120 and other objects in execution environment 110 is deferred until software application 120 is returned to active state. Accordingly, resources that may try to access software application 120, in the suspended state, will not encounter any errors.

In accordance with one aspect or embodiment, system software 114 may cause memory associated with a second page size (i.e., a page size other than the page size initially allocated to software application 120) to be allocated to software application 120, while software application 120 is in suspended mode (S350). For example, small size page 150 previously allocated to software application 130 may be remapped, under the control of system software 114, and allocated to software application 120. Further, large size page 140 may be deallocated from software application 120 and reallocated to software application 130 needing larger size pages than that already available in system memory.

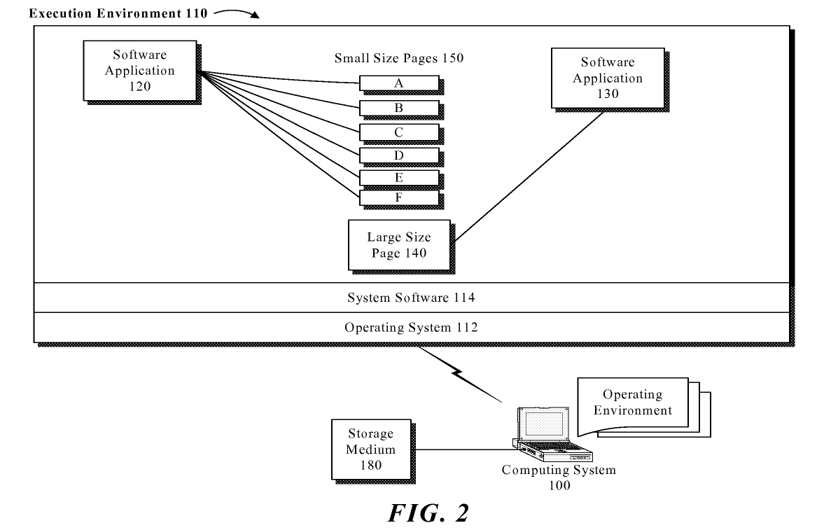

Thus, as shown in FIGS. 1 and 2, where many small size pages were initially allocated to software application 130 in a first execution context, the system software 114, for example, may determine that it would be more efficient to allocate to software application 130 a large size page 140 in a second execution context. Furthermore, referring to FIGS. 2 and 3, system software 114, for example, may determine that in a certain execution context, small size pages 150 A through F are more suitable for software application 120 and accordingly remap the memory so that small size pages 150 are allocated to software application 120 while it is in suspended state.

In accordance with one or more embodiments, once system software 114 has determined how to remap the available memory and page sizes, the application data and state information associated with a suspended application is loaded from storage medium 180 into system memory according to the remapping scheme and the suspended application resumes execution. Advantageously, the suspended application need not be fully terminated for the memory reallocation to take place. Rather, the application may enter a suspended state.

In summary, in the suspended state, a first page size allocated to a suspended application may be remapped to another application and the related data may be stored in a storage medium. When a second page size is allocated to the suspended application, the related data is reloaded into the newly mapped memory space for the suspended application. The off loading and reloading the respective data is transparent to the suspended application and requires no modification to the logic code or executable code for the suspended application.

Thus, in accordance with one aspect of the invention, the logic code for each application executing in execution environment 110 need not be modified or customized for the purpose of handling the allocation and reallocation process. Instead, system software 114 monitors and manages the memory requirements of applications executed on computing system 100 and handles the memory reallocation in a manner transparent to the application.

In different embodiments, the invention can be implemented either entirely in the form of hardware or entirely in the form of software, or a combination of both hardware and software elements. For example, computing system 100, operating system 112, and system software 114 may comprise a controlled computing system environment that can be presented largely in terms of hardware components and software code executed to perform processes that achieve the results contemplated by the system of the present invention.

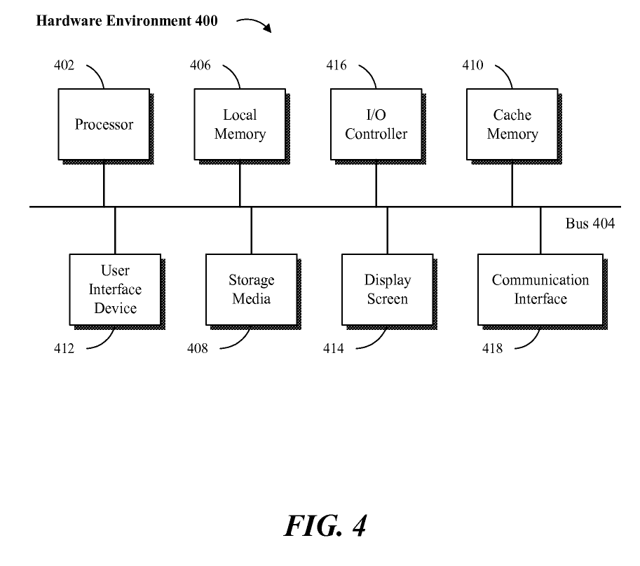

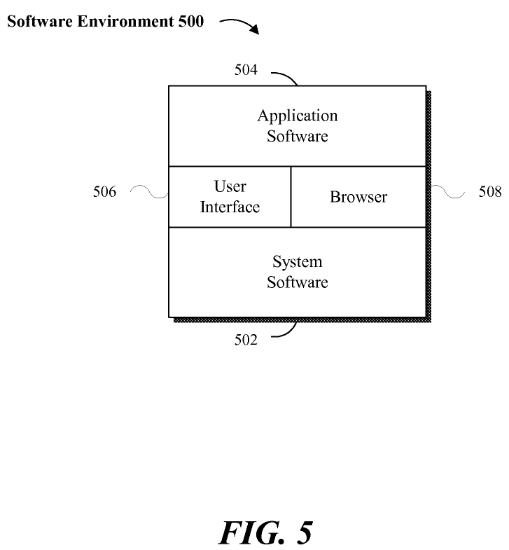

Referring to FIGS. 4 and 5, a computing system environment in accordance with an exemplary embodiment is composed of a hardware environment 400 and a software environment 500. The hardware environment 400 comprises the machinery and equipment that provide an execution environment for the software; and the software provides the execution instructions for the hardware as provided below.

As provided here, the software elements that are executed on the illustrated hardware elements are described in terms of specific logical/functional relationships. It should be noted, however, that the respective methods implemented in software may be also implemented in hardware by way of configured and programmed processors, ASICs (application specific integrated circuits), FPGAs (Field Programmable Gate Arrays) and DSPs (digital signal processors), for example.

Software environment 500 is divided into two major classes comprising system software 502 and application software 504. System software 502 comprises control programs, such as the operating system (OS) and information management systems that instruct the hardware how to function and process information.

In one embodiment, operating system 112 or system software 114 may be implemented as system software 502 or application software 504 executed on one or more hardware environments to facilitate management of memory in execution environment 110. Application software 504 may comprise but is not limited to program code, data structures, firmware, resident software, microcode or any other form of information or routine that may be read, analyzed or executed by a microcontroller.

In an alternative embodiment, the invention may be implemented as computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate or transport the program for use by or in connection with the instruction execution system, apparatus or device.

The computer-readable medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk read only memory (CD-ROM), compact disk read/write (CD-R/W) and digital videodisk (DVD).

Referring to FIG. 4, an embodiment of the system software 502 and application software 504 may be implemented as computer software in the form of computer readable code executed on a data processing system such as hardware environment 400 that comprises a processor 402 coupled to one or more computer readable media or memory elements by way of a system bus 404. The computer readable media or the memory elements, for example, can comprise local memory 406, storage media 408, and cache memory 410. Processor 402 loads executable code from storage media 408 to local memory 406. Cache memory 410 provides temporary storage to reduce the number of times code is loaded from storage media 408 for execution.

A user interface device 412 (e.g., keyboard, pointing device, etc.) and a display screen 414 can be coupled to the computing system either directly or through an intervening I/O controller 416, for example. A communication interface unit 418, such as a network adapter, may be also coupled to the computing system to enable the data processing system to communicate with other data processing systems or remote printers or storage devices through intervening private or public networks. Wired or wireless modems and Ethernet cards are a few of the exemplary types of network adapters.

In one or more embodiments, hardware environment 400 may not include all the above components, or may comprise other components for additional functionality or utility. For example, hardware environment 400 may be a laptop computer or other portable computing device embodied in an embedded system such as a set-top box, a personal data assistant (PDA), a mobile communication unit (e.g., a wireless phone), or other similar hardware platforms that have information processing and/or data storage and communication capabilities.

In certain embodiments of the system, communication interface 418 communicates with other systems by sending and receiving electrical, electromagnetic or optical signals that carry digital data streams representing various types of information including program code. The communication may be established by way of a remote network (e.g., the Internet), or alternatively by way of transmission over a carrier wave.

Referring to FIG. 5, system software 502 and application software 504 may comprise one or more computer programs that are executed on top of operating system 112 after being loaded from storage media 408 into local memory 406. In a client-server architecture, application software 504 may comprise client software and server software. For example, in one embodiment of the invention, client software is executed on computing systems 110 or 120 and server software is executed on a server system (not shown).

Software environment 500 may also comprise browser software 508 for accessing data available over local or remote computing networks. Further, software environment 500 may comprise a user interface 506 (e.g., a Graphical User Interface (GUI)) for receiving user commands and data. Please note that the hardware and software architectures and environments described above are for purposes of example, and one or more embodiments of the invention may be implemented over any type of system architecture or processing environment.

It should also be understood that the logic code, programs, modules, processes, methods and the order in which the respective steps of each method are performed are purely exemplary. Depending on implementation, the steps may be performed in any order or in parallel, unless indicated otherwise in the present disclosure. Further, the logic code is not related, or limited to any particular programming language, and may comprise of one or more modules that execute on one or more processors in a distributed, non-distributed or multiprocessing environment.

Therefore, it should be understood that the invention can be practiced with modification and alteration within the spirit and scope of the appended claims. The description is not intended to be exhaustive or to limit the invention to the precise form disclosed. These and various other adaptations and combinations of the embodiments disclosed are within the scope of the invention and are further defined by the claims and their full scope of equivalents.

What is claimed is:

1. A method for reallocating memory in a computing environment, the method comprising:
deallocating first memory space allocated to a first software application in a first execution context, in response to determining that a first page size associated with the first memory space allocation is inappropriate for said first software application within a second execution context; and
allocating a second memory space to the first software application responsive to the second execution context, such that a second page size associated with the second memory space allocation is appropriate for the first software application in the second execution context.

2. The method of claim 1 further comprising storing data stored in the first memory space in a third memory space, wherein the third memory space is independent from the first memory space.

3. The method of claim 2, wherein the first memory space comprises a volatile data storage medium.

4. The method of claim 2, wherein the third memory space comprises a non-volatile data storage medium.

5. The method of claim 2, further comprising storing state information about execution of the first software application in the third memory space.

6. The method of claim 1, further comprising restoring the first software application to same state as prior to deallocation from the first memory space, after the second memory space is allocated to the first software application.

7. The method of claim 1, wherein the deallocation of the first memory space is performed by a second software application that is executed independent of the first software application.

8. The method of claim 7, wherein the second software application comprises an operating system executing over a computing system.

9. The method of claim 1, wherein the second page size is larger than the first page size.

10. The method of claim 1, wherein the second page size is smaller than the first page size.

11. A system for detecting deadlock in a computing execution environment, the system comprising:
a logic unit for deallocating first memory space allocated to a first software application in a first execution context, in response to determining that a first page size associated with the first memory space allocation is inappropriate for said first software application within a second execution context; and
a logic unit for allocating a second memory space to the first software application responsive to the second execution context, such that a second page size associated with the second memory space allocation is appropriate for the first software application in the second execution context.

12. The system of claim 11 further comprising a logic unit for storing data stored in the first memory space in a third memory space, wherein the third memory space is independent from the first memory space.

13. The system of claim 12, wherein the first memory space comprises a volatile data storage medium.

14. The system of claim 12, wherein the third memory space comprises a non-volatile data storage medium.

15. The system of claim 12, further comprising storing state information about execution of the first software application in the third memory space.

16. A computer program product comprising a computer useable medium having a computer readable program, the computer readable program when executed on a computer causes the computer to:
deallocate first memory space allocated to a first software application in a first execution context, in response to determining that a first page size associated with the first memory space allocation is inappropriate for said first software application within a second execution context; and
allocate a second memory space to the first software application responsive to the second execution context, such that a second page size associated with the second memory space allocation is appropriate for the first software application in the second execution context.

17. The computer program product of claim 16, wherein the computer readable program when executed on a computer further causes the computer to:
store data stored in the first memory space in a third memory space, wherein the third memory space is independent from the first memory space.

18. The computer program product of claim 17, wherein the first memory space comprises a volatile data storage medium.

19. The computer program product of claim 17, wherein the third memory space comprises a non-volatile data storage medium.

20. The computer program product of claim 17, further comprising storing state information about execution of the first software application in the third memory space.
